(19) United States
(12) Patent Application Publication
(10) Pub. No.: US 2022/0350866 A1
(43) Pub. Date: Nov. 3, 2022

(54) MULTI-PATH LAYER CONFIGURED TO DE-OBFUSCATE LOGS PRODUCED BY MULTI-PATH INPUT-OUTPUT DRIVERS

(71) Applicant: EMC IP Holding Company LLC, Hopkinton, MA (US)

(72) Inventors: Surendra Singh Chauhan, Ajmer (IN); Udit Tyagi, Bangalore (IN)

(21) Appl. No.: 17/246,815

(22) Filed: May 3, 2021

(51) Int. Cl. G06F 21/14; G06F 21/78; G06F 21/62; G06F 21/31; G06F 8/65

(52) U.S. Cl. CPC G06F 21/14; G06F 21/78; G06F 21/6209; G06F 21/31; G06F 8/65

(57) ABSTRACT

An apparatus comprises a processing device configured to provide, to a given multi-path input-output driver of a given host device, obfuscated software code of at least a given portion of a given piece of software. The processing device is also configured to receive from the given multi-path input-output driver obfuscated log files produced by running the obfuscated software code of the given portion of the given piece of software, to generate de-obfuscated log files utilizing a mapping between the obfuscated software code of the given portion of the given piece of software and corresponding un-obfuscated software code of the given portion of the given piece of software, to analyze the de-obfuscated log files to identify actions to be performed for issues encountered by the given multi-path input-output driver, and to perform the actions to resolve the issues encountered by the given multi-path input-output driver.

### FIELD

The present invention relates generally to the field of information processing, and more particularly to storage in information processing systems.

### BACKGROUND

Storage arrays and other types of storage systems are often shared by multiple host devices over a network. Applications running on the host devices each include one or more processes that perform the application functionality. The processes issue input-output (IO) operations directed to particular logical storage volumes or other logical storage devices, for delivery by the host devices over selected paths to storage ports of the storage system. Different ones of the host devices can run different applications with varying workloads and associated IO patterns. Such host devices also generate additional IO operations in performing various data services such as migration and replication. Various types of storage access protocols can be used by host devices to access the logical storage volumes or other logical storage devices of the storage system, including by way of example Small Computer System Interface (SCSI) access protocols and Non-Volatile Memory Express (NVMe) access protocols.

### SUMMARY

Illustrative embodiments of the present disclosure provide techniques for de-obfuscation of obfuscated logs produced by multi-path input-output drivers utilizing a multi-path layer of an information processing system.

In one embodiment, an apparatus comprises at least one processing device comprising a processor coupled to a memory. The at least one processing device is configured to perform the step of providing, to a given multi-path input-output driver of a given one of a plurality of host devices that utilize a given piece of software for controlling delivery of input-output operations to a storage system over selected ones of a plurality of paths through a network, obfuscated software code of at least a given portion of the given piece of software. The at least one processing device is also configured to perform the steps of receiving, from the given multi-path input-output driver of the given host device, one or more obfuscated log files produced by the given multi-path input-output driver running the obfuscated software code of the given portion of the given piece of software, and generating one or more de-obfuscated log files from the one or more obfuscated log files utilizing a mapping between the obfuscated software code of the given portion of the given piece of software and corresponding un-obfuscated software code of the given portion of the given piece of software. The at least one processing device is further configured to perform the steps of analyzing the one or more de-obfuscated log files to identify one or more actions to be performed for one or more issues encountered by the given multi-path input-output driver, and performing the one or more actions to resolve the one or more issues encountered by the given multi-path input-output driver.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for de-obfuscating logs produced by multi-path input-output drivers in an illustrative embodiment.

FIG. 2 is a block diagram showing further detail of the support platform of the FIG. 1 information processing system in an illustrative embodiment.

FIG. 3 shows a system flow for de-obfuscating logs generated from obfuscated code of software products in an illustrative embodiment.

FIG. 4 shows an example of code obfuscation and de-obfuscation using a mapping table in an illustrative embodiment.

FIG. 5 is a flow diagram of an exemplary process for de-obfuscating logs produced by multi-path input-output drivers in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

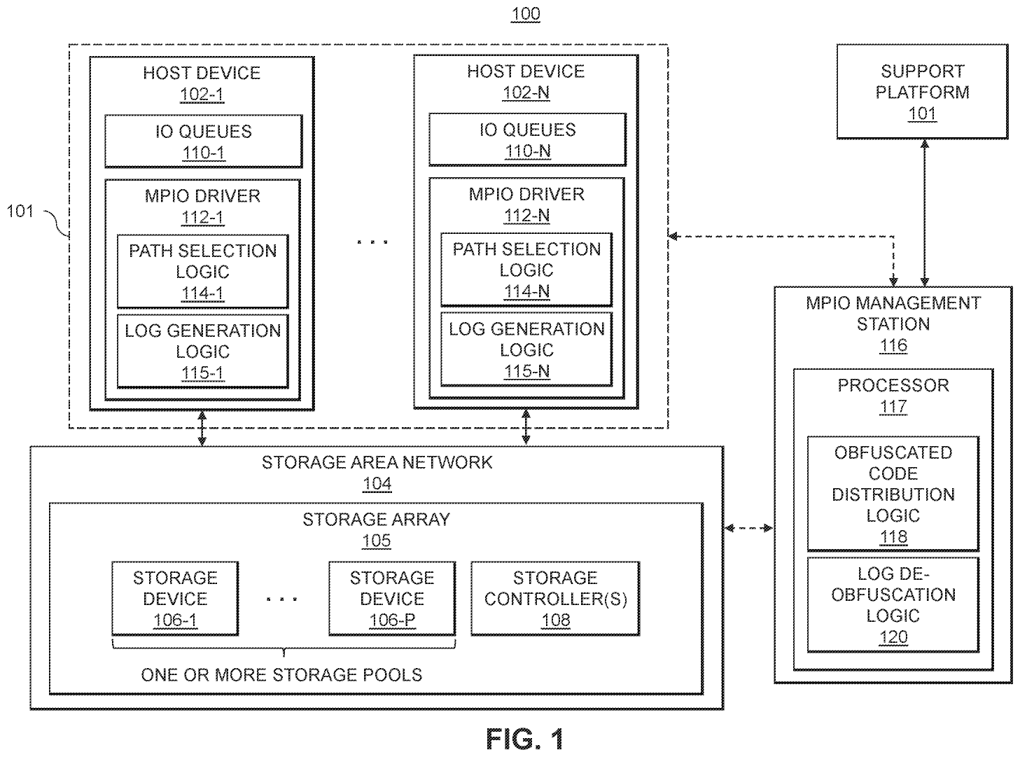

FIG. 1 shows an information processing system 100 configured in accordance with an illustrative embodiment. The information processing system 100 comprises a plurality of host devices 102-1, . . . 102-N (collectively, host devices 102), where N is an integer greater than or equal to two. The host devices 102 communicate over a storage area network (SAN) 104 with at least one storage array 105. The storage array 105 comprises a plurality of storage devices 106-1, . . . 106-P (collectively, storage devices 106) each storing data utilized by one or more applications running on one or more of the host devices 102, where P is also an integer greater than or equal to two. The storage devices 106 are illustratively arranged in one or more storage pools.

The storage array 105 and its associated storage devices 106 are an example of what is more generally referred to herein as a “storage system.” This storage system in the present embodiment is shared by the host devices 102, and is therefore also referred to herein as a “shared storage system.” Other embodiments can include only a single host device, possibly configured to have exclusive use of the storage system.

The host devices 102 illustratively comprise respective computers, servers or other types of processing devices capable of communicating with the storage array 105 of the SAN 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 106 of the storage array 105 of SAN 104 implement logical units (LUNs) configured to store objects for users associated with the host devices 102. These objects can comprise files, blocks or other types of objects. The host devices 102 interact with the storage array 105 utilizing read and write commands as well as other types of commands that are transmitted over the SAN 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output.

Also, the term “storage device” as used herein is intended to be broadly construed, so as to encompass, for example, a logical storage device such as a LUN or other logical storage volume. A logical storage device can be defined in the storage array 105 to include different portions of one or more physical storage devices. Storage devices 106 may therefore be viewed as comprising respective LUNs or other logical storage volumes.

Each of the host devices 102 illustratively has multiple paths to the storage array 105, with at least one of the storage devices 106 of the storage array 105 being visible to that host device on a given one of the paths. A given one of the storage devices 106 may be accessible to the given host device over multiple paths.

Different ones of the storage devices 106 of the storage array 105 illustratively exhibit different latencies in processing of IO operations. In some cases, the same storage device may exhibit different latencies for different ones of multiple paths over which that storage device can be accessed from a given one of the host devices 102.

The host devices 102, SAN 104 and storage array 105 in the FIG. 1 embodiment are assumed to be implemented using at least one processing platform each comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102 and the storage array 105 may be implemented on respective distinct processing platforms, although numerous other arrangements are possible. For example, in some embodiments at least portions of the host devices 102 and the storage array 105 are implemented on the same processing platform. The storage array 105 can therefore be implemented at least in part within at least one processing platform that implements at least a subset of the host devices 102.

The SAN 104 may be implemented using multiple networks of different types to interconnect storage system components. For example, the SAN 104 may comprise a portion of a global computer network such as the Internet, although other types of networks can be part of the SAN 104, including a wide area network (WAN), a local area network (LAN), a satellite network, a telephone or cable network, a cellular network, a wireless network such as a WiFi or WiMAX network, or various portions or combinations of these and other types of networks. The SAN 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The host devices 102 comprise respective sets of IO queues 110-1, . . . 110-N (collectively, IO queues 110) and respective MPIO drivers 112-1, . . . 112-N (collectively, MPIO drivers 112). The MPIO drivers 112 collectively comprise a multi-path layer of the host devices 102. Path selection functionality for delivery of IO operations from the host devices 102 to the storage array 105 is provided in the multi-path layer by respective instances of path selection logic 114-1, . . . 114-N (collectively, path selection logic 114) implemented within the MPIO drivers 112.

The MPIO drivers 112 may comprise, for example, otherwise conventional MPIO drivers, such as PowerPath® drivers from Dell EMC, suitably modified in the manner disclosed herein to provide functionality for dynamic control of one or more path selection algorithms. Other types of MPIO drivers from other driver vendors may be suitably modified to incorporate functionality for dynamic control of one or more path selection algorithms as disclosed herein.

The term “MPIO driver” as used herein is intended to be broadly construed, and such a component is illustratively implemented at least in part as a combination of software and hardware. For example, one or more of the MPIO drivers 112 can comprise one or more software programs running on a hardware processor of one or more of the host devices 102.

The host devices 102 can include additional or alternative components. For example, in some embodiments, the host devices 102 comprise respective local caches, implemented using respective memories of those host devices. A given such local cache can be implemented using one or more cache cards, possibly implementing caching techniques such as those disclosed in U.S. Pat. Nos. 9,201,803, 9,430,368 and 9,672,160, each entitled “System and Method for Caching Data,” and incorporated by reference herein. A wide variety of different caching techniques can be used in other embodiments, as will be appreciated by those skilled in the art. Other examples of memories of the respective host devices 102 that may be utilized to provide local caches include one or more memory cards or other memory devices, such as, for example, an NVMe over PCIe cache card, a local flash drive or other type of NVM storage drive, or combinations of these and other host memory devices.

The system 100 further comprises an MPIO management station 116 that includes a processor 117 implementing obfuscated code distribution logic 118 and log de-obfuscation logic 120. The obfuscated code distribution logic 118, as will be described in further detail below, is configured to distribute or otherwise provide obfuscated code of at least a portion of one or more software programs (e.g., the MPIO drivers 112) to the host devices 102. The log de-obfuscation logic 120, as will be described in further detail below, is configured to receive obfuscated logs generated by the log generation logic 115-1, . . . 115-N of the host devices 102. The obfuscated logs, for example, may be generated by the host devices 102 utilizing the obfuscated code of at least a portion of the MPIO drivers 112 previously provided to the host devices 102 by the obfuscated code distribution logic 118. The log de-obfuscation logic 120 is configured to de-obfuscate the obfuscated logs, such as using an encrypted mapping file as described in further detail below.

The MPIO management station 116 provides management functionality for the multi-path layer comprising the MPIO drivers 112 of the host devices 102. In some embodiments, host device management software executing on the MPIO management station 116 interacts with storage array management software executing on the storage array 105. The MPIO management station 116, or portions thereof, may be considered in some embodiments as forming part of what is referred to herein as a “multi-path layer” that includes the MPIO drivers 112 of the host devices 102. The term “multi-path layer” as used herein is intended to be broadly construed and may comprise, for example, an MPIO layer or other multi-path software layer of a software stack, or more generally multi-pathing software program code, running on one or more processing devices each comprising at least one processor and at least one memory.

The MPIO management station 116 is an example of what is more generally referred to herein as an “external server” relative to the storage array 105. Additional or alternative external servers of different types can be used in other embodiments.

The MPIO driver 112-1 is configured to deliver IO operations selected from its corresponding set of IO queues 110-1 to the storage array 105 via selected ones of multiple paths over the SAN 104. The sources of the IO operations stored in the set of IO queues 110-1 illustratively include respective processes of one or more applications executing on the host device 102-1. For example, IO operations can be generated by each of multiple processes of a database application running on the host device 102-1. Such processes issue IO operations for delivery to the storage array 105 over the SAN 104. Other types of sources of IO operations may be present in a given implementation of system 100.

The paths from the host device 102-1 to the storage array 105 illustratively comprise paths associated with respective initiator-target pairs, with each initiator comprising a host bus adaptor (HBA) or other initiating entity of the host device 102-1 and each target comprising a port or other targeted entity corresponding to one or more of the storage devices 106 of the storage array 105. As noted above, the storage devices 106 illustratively comprise LUNs or other types of logical storage devices.

In some embodiments, the paths are associated with respective communication links between the host device 102-1 and the storage array 105 with each such communication link having a negotiated link speed. For example, in conjunction with registration of a given HBA to a switch of the SAN 104, the HBA and the switch may negotiate a link speed. The actual link speed that can be achieved in practice in some cases is less than the negotiated link speed, which is a theoretical maximum value. A negotiated link speed is an example of what is more generally referred to herein as a “negotiated rate.”

The negotiated rates of the respective initiator and target of a particular one of the paths illustratively comprise respective negotiated data rates determined by execution of at least one link negotiation protocol for that path. The link negotiation protocol is illustratively performed separately by the initiator and the target, and involves each such component separately interacting with at least one switch of a switch fabric of the SAN 104 in order to determine the negotiated rate. The term “negotiated rate” therefore illustratively comprises a rate negotiated between an initiator or a target and a switch of a switch fabric of the SAN 104. However, the term “negotiated rate” as used herein is intended to be broadly construed so as to also encompass, for example, arrangements that refer to negotiated speeds. Any of a wide variety of different link negotiation protocols can be used, including auto-negotiation protocols, as will be readily appreciated by those skilled in the art.

For example, some embodiments are configured to utilize link negotiation protocols that allow negotiation of data rates such as 1G, 2G, 4G, 8G, 16G, 32G, etc., where G denotes Gigabits per second (Gb/sec). The link bandwidth is illustratively specified in terms of Megabytes per second (MB/sec), and the actual amount of data that can be sent over the link in practice is typically somewhat lower than the negotiated data rate. Accordingly, a negotiated rate of 1G in some systems may correspond to an actual achievable data rate that is lower than 100 MB/sec, such as a rate of 85 MB/sec.

The term “negotiated rate” as used herein is therefore intended to be broadly construed, so as to encompass, for example, a theoretical negotiated rate or an actual achievable data rate that corresponds to the theoretical negotiated rate within a given system.

It is also to be appreciated that a wide variety of other types of rate negotiation may be performed in other embodiments.

Various scheduling algorithms, load balancing algorithms and/or other types of algorithms can be utilized by the MPIO driver 112-1 in delivering IO operations from the IO queues 110-1 to the storage array 105 over particular paths via the SAN 104. Each such IO operation is assumed to comprise one or more commands for instructing the storage array 105 to perform particular types of storage-related functions such as reading data from or writing data to particular logical volumes of the storage array 105. Such commands are assumed to have various payload sizes associated therewith, and the payload associated with a given command is referred to herein as its “command payload.”

A command directed by the host device 102-1 to the storage array 105 is considered an “outstanding” command until such time as its execution is completed in the viewpoint of the host device 102-1, at which time it is considered a “completed” command. The commands illustratively comprise respective SCSI commands, although other command formats can be used in other embodiments. A given such command is illustratively defined by a corresponding command descriptor block (CDB) or similar format construct. The given command can have multiple blocks of payload associated therewith, such as a particular number of 512-byte SCSI blocks or other types of blocks.

In illustrative embodiments to be described below, it is assumed without limitation that the initiators of a plurality of initiator-target pairs comprise respective HBAs of the host device 102-1 and that the targets of the plurality of initiator-target pairs comprise respective ports of the storage array 105.

Selecting a particular one of multiple available paths for delivery of a selected one of the IO operations of the set of IO queues 110-1 is more generally referred to herein as “path selection.” Path selection as that term is broadly used herein can in some cases involve both selection of a particular IO operation and selection of one of multiple possible paths for accessing a corresponding logical device of the storage array 105. The corresponding logical device illustratively comprises a LUN or other logical storage volume to which the particular IO operation is directed.

It should be noted that paths may be added or deleted between the host devices 102 and the storage array 105 in the system 100. For example, the addition of one or more new paths from host device 102-1 to the storage array 105 or the deletion of one or more existing paths from the host device 102-1 to the storage array 105 may result from respective addition or deletion of at least a portion of the storage devices 106 of the storage array 105.

Addition or deletion of paths can also occur as a result of zoning and masking changes or other types of storage system reconfigurations performed by a storage administrator or other user. Some embodiments are configured to send a predetermined command from the host device 102-1 to the storage array 105, illustratively utilizing the MPIO driver 112-1, to determine if zoning and masking information has been changed. The predetermined command can comprise, for example, a log sense command, a mode sense command, a “vendor unique” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the storage array 105 as well to discover the disappearance of any existing LUNs that have been deleted from the storage array 105.

The MPIO driver 112-1 in some embodiments comprises a user-space portion and a kernel-space portion. The kernel-space portion of the MPIO driver 112-1 may be configured to detect one or more path changes of the type mentioned above, and to instruct the user-space portion of the MPIO driver 112-1 to run a path discovery scan responsive to the detected path changes. Other divisions of functionality between the user-space portion and the kernel-space portion of the MPIO driver 112-1 are possible. The user-space portion of the MPIO driver 112-1 is illustratively associated with an Operating System (OS) kernel of the host device 102-1. Other MPIO driver arrangements are possible. For example, in some embodiments, an MPIO driver may be configured using a kernel-based implementation, and in such an arrangement may include only a kernel-space portion and no user-space portion.

For each of one or more new paths identified in the path discovery scan, the host device 102-1 may be configured to execute a host registration operation for that path. The host registration operation for a given new path illustratively provides notification to the storage array 105 that the host device 102-1 has discovered the new path.

The MPIO driver 112-1 is further configured to determine IO processing performance for each of at least a subset of the paths, and to dynamically adjust a path selection algorithm, utilized by the path selection logic 114-1 in selecting particular ones of the paths for delivery of the IO operations from the host device 102-1 to the storage array 105, based at least in part on the determined performance.

In determining IO processing performance of respective paths, the MPIO driver 112-1 obtains information such as, for example, response times or other latency measures of the respective paths. This information is illustratively referred to in the context of some embodiments herein as “path condition information,” although other types of information can be used in other embodiments. Dynamic control of one or more path selection algorithms is therefore performed in some embodiments using latency measures.

The above-noted process of determining IO processing performance for each of at least a subset of the paths and dynamically adjusting a path selection algorithm utilized in selecting particular ones of the paths for delivery of the IO operations from the host device to the storage array 105 based at least in part on the determined performance are illustratively repeated in each of a plurality of intervals. The particular duration of such time periods can be a user-configurable parameter, or set by default, and can vary depending upon factors such as the desired resolution of the IO processing performance information and the amount of overhead required to determine that information.

In the FIG. 1 embodiment, the storage array 105 comprises one or more storage controllers 108. The storage controllers 108 may maintain per-port IO processing information. Such per-port IO processing information is illustratively collected by the storage array 105, and in some embodiments may be provided to one or more of the host devices 102 for use in conjunction with path selection.

The MPIO management station 116 is arranged as an intermediary device relative to the host devices 102 and the storage array 105. Some communications between the host devices 102 and the storage array 105 can occur via such an intermediary device, which as indicated elsewhere herein can alternatively comprise one or more external servers. Such communications illustratively involve utilization of an out-of-band communication mechanism, such as one or more IP connections between the host devices 102 and the MPIO management station 116.

As indicated previously, the host devices 102 communicate directly with the storage array 105 using one or more storage access protocols such as SCSI, Internet SCSI (iSCSI), SCSI over FC (SCSI-FC), NVMe over FC (NVMe/FC), NVMe over Fabrics (NVMeF), NVMe over TCP (NVMe/TCP), and/or others. The MPIO management station 116 in some embodiments is similarly configured to communicate directly with the storage array 105 using one or more such storage access protocols.

The MPIO driver 112-1 on the host device 102-1 illustratively has connectivity to the MPIO management station 116. The MPIO management station 116 in some embodiments implements PowerPath® Management Appliance (PPMA) functionality to obtain access to the storage array 105. The MPIO driver 112-1 can obtain from the MPIO management station 116 certain types of storage array related information for use in various operations performed at least in part by the MPIO driver 112-1, in addition to or in place of obtaining such information directly from the storage array 105. Host multi-pathing software can be used to implement a multi-path layer comprising MPIO drivers 112 of respective host devices 102 as well as related management appliance software such as the above-noted PPMA of MPIO management station 116. Such host multi-pathing software can be configured to facilitate logical storage device access as disclosed herein.

It should be noted that various logic components (e.g., path selection logic 114, log generation logic 115, obfuscate code distribution logic 118, log de-obfuscation logic 120, etc.) disclosed herein can include various combinations of hardware, firmware and software. The term “logic” as used herein is therefore intended to be broadly construed.

As indicated above, at least portions of the communications between the host devices 102 and the storage array 105 can utilize an in-band communication mechanism in which one or more predetermined commands in a designated storage access protocol are sent from the host device 102-1 to the storage array 105. Such predetermined commands can comprise, for example, read and/or write commands, sense commands (e.g., log sense and/or mode sense commands), “vendor unique” or VU commands, or combinations of multiple instances of these or other commands, in an otherwise standardized command format, such as a SCSI format, an NVMe format, or other type of format. A “command” as the term is broadly used herein can comprise a combination of multiple distinct commands.

It is also possible for the host devices 102 and the storage array 105 to communicate via one or more out-of-band communication mechanisms. For example, an out-of-band communication mechanism of this type can involve host management software of the host device 102-1 communicating with storage array management software of the storage array 105 over an IP network connection or other type of network connection. Such host management software can include software running on the MPIO management station 116, in addition to or in place of software running on the individual host devices 102.

Additional components not explicitly shown in the figure, such as one or more storage caches, may also be provided in the storage array 105 for use in processing IO operations. For example, in some embodiments, each of the storage controllers 108 has a different local cache or a different allocated portion of a global cache associated therewith, although numerous alternative arrangements are possible. The storage controllers 108 can be implemented as respective storage processors, directors or other storage system components configured to control storage system operations relating to processing of IO operations.

It is assumed that each of the other MPIO drivers 112 is configured in a manner similar to that described above and elsewhere herein for the first MPIO driver 112-1. The other host devices 102 of the system 100 are therefore also configured to communicate over the SAN 104 with the storage array 105. The MPIO drivers 112 of such other host devices are each similarly configured to deliver IO operations from its corresponding one of the sets of IO queues 110 to the storage array 105 over selected paths through the SAN 104.

Accordingly, functionality described above in the context of the first MPIO driver 112-1 and the first host device 102-1 is assumed to be similarly performed by each of the other MPIO drivers 112 and/or more generally by their respective host devices 102.

The MPIO drivers 112 may be otherwise configured utilizing well-known multi-pathing functionality. Such conventional multi-pathing functionality is suitably modified in illustrative embodiments disclosed herein to support access authorization for at least a portion of software code of the MPIO driver 112.

Although in some embodiments certain commands used by the host devices 102 to communicate with the storage array 105 illustratively comprise SCSI commands, other types of commands and command formats can be used in other embodiments. For example, some embodiments can implement IO operations utilizing command features and functionality associated with NVMe, as described in the NVMe Specification, Revision 1.3, May 2017, which is incorporated by reference herein. Other NVMe storage access protocols of this type that may be utilized in illustrative embodiments disclosed herein include NVMe/FC, NVMeF and NVMe/TCP.

The storage array 105 in the present embodiment is assumed to comprise a persistent memory that is implemented using a flash memory or other type of non-volatile memory of the storage array 105. More particular examples include NAND-based flash memory or other types of non-volatile memory such as resistive RAM, phase change memory, spin torque transfer magneto-resistive RAM (STT-MRAM) and Intel Optane™ devices based on 3D XPoint™ memory. The persistent memory is further assumed to be separate from the storage devices 106 of the storage array 105, although in other embodiments the persistent memory may be implemented as a designated portion or portions of one or more of the storage devices 106. For example, in some embodiments the storage devices 106 may comprise flash-based storage devices, as in embodiments involving all-flash storage arrays, or may be implemented in whole or in part using other types of non-volatile memory.

The storage array 105 in the present embodiment may comprise additional components not explicitly shown in the figure, such as a response time control module and IO operation priority queues, illustratively configured to make use of the above-described persistent memory. For example, the response time control module may be used to implement storage array based adjustments in response time for particular IO operations based at least in part on service level objective (SLO) information stored by the storage array 105 in its persistent memory. The response time control module is assumed to operate in conjunction with the above-noted IO operation priority queues.

The storage array 105 illustratively utilizes its IO operation priority queues to provide different levels of performance for IO operations. For example, the IO operation priority queues may have respective different priority levels. The storage array 105 may be configured to provide different priority levels for different ones of the IO operations by assigning different ones of the IO operations to different ones of the IO operation priority queues. The IO operation priority queues are illustratively associated with respective SLOs for processing of IO operations in the storage array 105. Process tags may be used in assigning different ones of the IO operations to different ones of the IO operation priority queues, as disclosed in U.S. Pat. No. 10,474,367, entitled “Storage System with Input-Output Performance Control Utilizing Application Process Detection,” which is incorporated by reference herein.

As mentioned above, communications between the host devices 102 and the storage array 105 may utilize PCIe connections or other types of connections implemented over one or more networks. For example, illustrative embodiments can use interfaces such as Internet SCSI (iSCSI), Serial Attached SCSI (SAS) and Serial ATA (SATA). Numerous other interfaces and associated communication protocols can be used in other embodiments.

The storage array 105 in some embodiments may be implemented as part of cloud infrastructure in the form of a cloud-based system.

The storage devices 106 of the storage array 105 can be implemented using solid state drives (SSDs). Such SSDs are implemented using non-volatile memory (NVM) devices such as flash memory. Other types of NVM devices that can be used to implement at least a portion of the storage devices 106 include non-volatile random access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 106.

The storage array 105 may additionally or alternatively be configured to implement multiple distinct storage tiers of a multi-tier storage system. By way of example, a given multi-tier storage system may comprise a fast tier or performance tier implemented using flash storage devices or other types of SSDs, and a capacity tier implemented using HDDs, possibly with one or more such tiers being server based. A wide variety of other types of storage devices and multi-tier storage systems can be used in other embodiments, as will be apparent to those skilled in the art. The particular storage devices used in a given storage tier may be varied depending on the particular needs of a given embodiment, and multiple distinct storage device types may be used within a single storage tier. As indicated previously, the term “storage device” as used herein is intended to be broadly construed, and so may encompass, for example, SSDs, HDDs, flash drives, hybrid drives or other types of storage products and devices, or portions thereof, and illustratively include logical storage devices such as LUNs.

As another example, the storage array 105 may be used to implement one or more storage nodes in a cluster storage system comprising a plurality of storage nodes interconnected by one or more networks.

It should therefore be apparent that the term “storage array” as used herein is intended to be broadly construed, and may encompass multiple distinct instances of a commercially-available storage array. For example, the storage array 105 may comprise one or more storage arrays such as one or more Unity™ or PowerMax™ storage arrays, commercially available from Dell Technologies.

Other types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

In some embodiments, a storage system comprises first and second storage arrays arranged in an active-active configuration. For example, such an arrangement can be used to ensure that data stored in one of the storage arrays is replicated to the other one of the storage arrays utilizing a synchronous replication process. Such data replication across the multiple storage arrays can be used to facilitate failure recovery in the system 100. One of the storage arrays may therefore operate as a production storage array relative to the other storage array which operates as a backup or recovery storage array.

It is to be appreciated, however, that embodiments disclosed herein are not limited to active-active configurations or any other particular storage system arrangements. Accordingly, illustrative embodiments herein can be configured using a wide variety of other arrangements, including, by way of example, active-passive arrangements, active-active Asymmetric Logical Unit Access (ALUA) arrangements, and other types of ALUA arrangements.

These and other storage systems can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. Thus, it is possible in some implementations of the system 100 for different ones of the host devices 102 to reside in different data centers than the storage array 105.

Numerous other distributed implementations of the host devices 102 and/or the storage array 105 are possible. Accordingly, the storage array 105 can also be implemented in a distributed manner across multiple data centers.

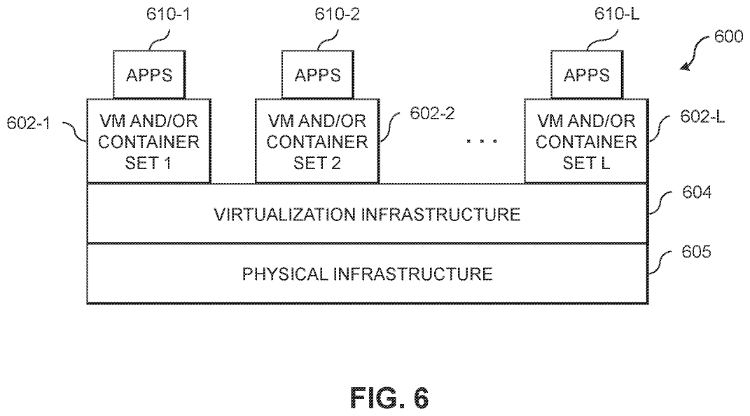

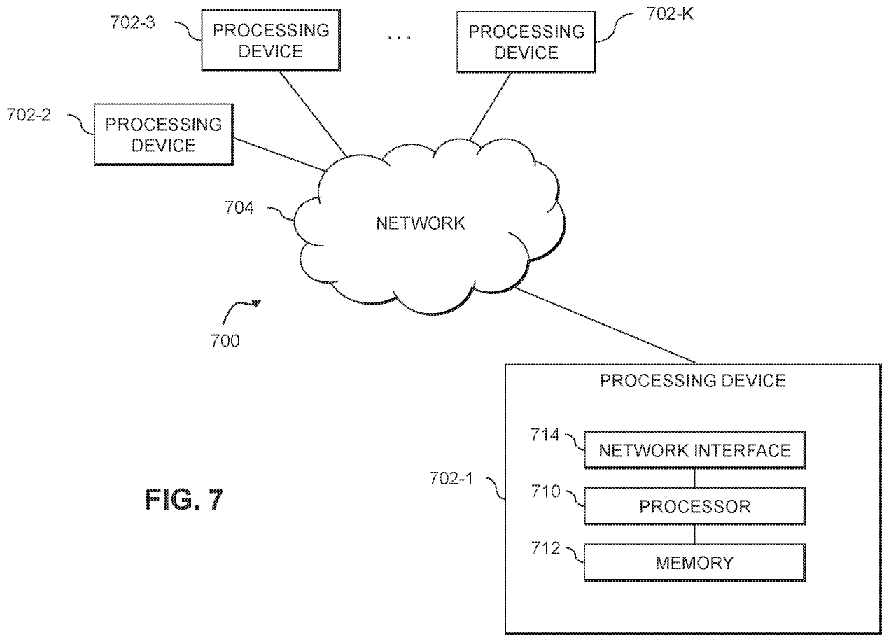

Additional examples of processing platforms utilized to implement portions of the system 100 in illustrative embodiments will be described in more detail below in conjunction with FIGS. 6 and 7.

An information technology (IT) infrastructure may utilize various different types of IT assets, such as different types of software across different servers or other computers of an enterprise network or system. The host devices 102 in FIG. 1, for example, may represent such an enterprise network or system. Software such as the MPIO drivers 112 may be distributed by an operator of the IT infrastructure to IT assets (e.g., the host devices 102). Log data produced by such IT assets may be analyzed to perform troubleshooting actions or otherwise monitor operation of the software running on the IT assets.

Ensuring the security of the computer code of various software programs can be a challenging task. For example, the MPIO drivers 112 or portions of the functionality thereof (e.g., path selection logic 114) may be provided in the form of one or more software programs which may be bundled in a readable format providing code transparency. For example, software programs may utilize code written in Java, which is provided to end-users in the form of one or more Java archives (e.g., a JAR or .jar package file format). Distributing such software programs may include providing such JAR files to end-users (e.g., bundled in a readable format providing code transparency).

Some groups or individuals may thus try to reverse engineer the code of software programs to exploit it for personal gain. Such groups or individuals may try to tamper with the software programs, bypass restrictions imposed by licenses for the software programs (e.g., to be able to use a given software program for an indefinite period of time rather than a definite or limited period of time specified by a license for the given software program, to gain unauthorized access to the given software program or features or functionality thereof, etc.), combinations thereof. Reverse engineering of code can be done easily using available de-compilers. The decompiled code can be easily tampered with, and bundled again with an intent to misuse it.

To combat the above issues, at least a portion of the code of an application or software program may be obfuscated. The use of open source tools for obfuscating code, however, provides various risks when bundling the code of applications or software programs. Consider, as an example, an organization (e.g., a business, enterprise or other type of entity) which distributes an application (e.g., MPIO drivers 112, path selection logic 114, etc.) to its members. Various Java archives or JAR files may be bundled internally within an application, and shared as part of distributing that application to the members of the organization. Further, after obfuscation of code of an application utilizing open source tools, application logs or traces generated by that application are difficult to read (e.g., as method names and stack traces will have obfuscated tags which can make application debugging impossible).

In some embodiments, to protect code from malicious users, approaches are utilized for adding security to the code of applications or software programs. Security is illustratively added through code obfuscation, such as a data obfuscation including syntactic lexical modifications. For example, obfuscation of a Java archive or JAR file may be performed to map various tags. The mapping of such tags may be stored in an encrypted mapping file, with a key utilizable for decrypting the encrypted mapping file being kept hidden from end-users.

The MPIO management station 116, as noted above, implements obfuscated code distribution logic 118 that is configured to distribute or otherwise provide obfuscated code for at least a portion of one or more software programs (e.g., the MPIO drivers 112) of the host devices 102. The host devices 102 are assumed to comprise production hosts in a data center or other enterprise system, with associated MPIO drivers 112 hosting live functionality (e.g., of path selection logic 114). The host devices 102 are thus also referred to herein as production hosts 102. In the system of FIG. 1, the production hosts 102 may be viewed as “end-users” which receive at least a portion of the MPIO drivers 112 in the form of one or more bundled JAR files which have been obfuscated from the obfuscated code distribution logic 118 of the MPIO management station 116.

The production hosts 102 may utilize the MPIO drivers 112 and generate application traces or other logs. Such application traces or other logs, being produced from running obfuscated code of the application, will also be obfuscated. Such obfuscated logs may be provided from the production hosts 102 to a designated entity for analysis. The designated entity may be, for example, the MPIO management station 116. The designated entity may also or alternatively be a support platform 101. The support platform 101, for example, may be associated with an operator of an enterprise system or data center that includes the production hosts 102 and is responsible for providing support for the MPIO drivers 112 running on the production hosts 102. The MPIO management station 116 and/or support platform 101 are assumed to have access to the key that is utilizable for decrypting the encrypted mapping file, and can thus de-obfuscate traces or other logs received from the production hosts 102 (e.g., to see exact method calls and error traces).

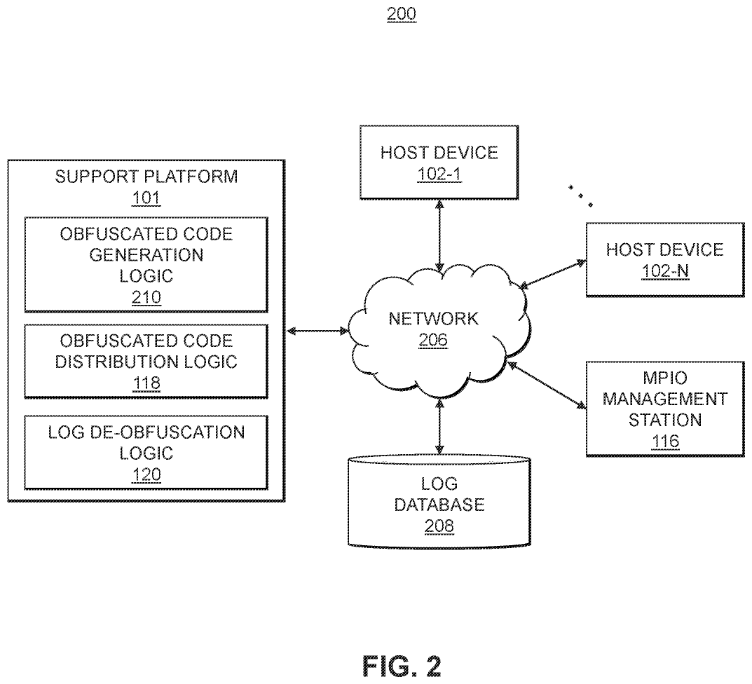

In the FIG. 1 system, the MPIO management station 116 implements the obfuscated code distribution logic 118 that is configured to distribute or otherwise provide obfuscated code to the production hosts 102, where the obfuscated code may include at least a portion of the software code of the MPIO drivers 112, or of one or more other applications which either run as part of the MPIO drivers 112 (e.g., the path selection logic 114) or which run outside of the MPIO drivers 112 on the production hosts 102. The MPIO management station 116 also implements the log de-obfuscation logic 120, which is configured to receive obfuscated traces or other logs generated by the log generation logic 115 of the production hosts 102, and to de-obfuscate the traces or other logs (e.g., by decrypting an encrypted mapping file as described above). The MPIO drivers 112 of the production hosts 102 implement respective instances of the log generation logic 115 which generates obfuscated traces or other logs (e.g., as part of running obfuscated code received from the obfuscated code distribution logic 118 of the MPIO management station 116). Such obfuscated traces or other logs are provided to the MPIO management station 116 (or to the support platform 101, as described in further detail below with respect to FIG. 2) for analysis.

The MPIO management station 116 may be integrated with a management appliance (e.g., a PowerPath® Management Appliance (PPMA) suitably modified to provide the functionality described herein) that is in communication with the MPIO drivers 112 of the production hosts 102 (e.g., PowerPath® hosts). Such communication may utilize one or more representational state transfer (REST) or other application programming interface (APIs) of the MPIO drivers 112, which are leveraged for performing various code obfuscation and de-obfuscation tasks described herein. Thus, there is no additional requirement for having a dedicated private network for such obfuscation and de-obfuscation tasks. It should be noted, however, that a dedicated private network may be used in some embodiments if desired.

It is to be appreciated that these and other features of illustrative embodiments are presented by way of example only, and should not be construed as limiting in any way. Accordingly, different numbers, types and arrangements of system components such as host devices 102, SAN 104, storage array 105, storage devices 106, sets of IO queues 110, MPIO drivers 112, path selection logic 114, log generation logic 115, obfuscated code distribution logic 118 and log de-obfuscation logic 120 can be used in other embodiments.

It should also be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

Although FIG. 1 shows the MPIO management station 116 implementing the obfuscated code distribution logic 118 and the log de-obfuscation logic 120, in other embodiments such logic and their associated functionality may also or alternatively be implemented within the support platform 101 as shown in the information processing system 200 of FIG. 2. FIG. 2 illustrates the support platform 101 connected to the production hosts 102 (e.g., host devices 102-1, 102-2, . . . 102-N) and the MPIO management station 116 via network 206. The production hosts 102 and MPIO management station 116 are examples of what are more generally referred to herein as “client devices” and may comprise, for example, physical computing devices such as Internet of Things (IoT) devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The production hosts 102 and MPIO management station 116 may also or alternatively comprise virtualized computing resources, such as virtual machines (VMs), containers, etc.

The production hosts 102 and MPIO management station 116 in some embodiments comprise respective computers associated with a particular company, organization or other enterprise. In addition, at least portions of the information processing system 200 in FIG. 2 may also be referred to herein as collectively comprising an “enterprise.” Numerous other operating scenarios involving a wide variety of different types and arrangements of processing nodes are possible, as will be appreciated by those skilled in the art. In some embodiments, the production hosts 102 and MPIO management station 116 may comprise assets of an information technology (IT) infrastructure operated by an enterprise, with the support platform 101 providing support services for such assets.

The network 206 is assumed to comprise a global computer network such as the Internet, although other types of networks can be part of the network 206, including a WAN, a LAN, a satellite network, a telephone or cable network, a cellular network, a wireless network such as a WiFi or WiMAX network, or various portions or combinations of these and other types of networks.

As noted above, in some embodiments the support platform 101 is used for providing support services for an enterprise system (e.g., an IT infrastructure comprising the production hosts 102 and MPIO management station 116). For example, an enterprise may subscribe to or otherwise utilize the support platform 101 to manage a set of assets (e.g., the production hosts 102 and MPIO management station 116) operated by users of the enterprise. As used herein, the term “enterprise system” is intended to be construed broadly to include any group of systems or other computing devices. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

Also coupled to the network 206 in the information processing system 200 in FIG. 2 is a log database 208, which is configured to store and record traces or other logs generated by the production hosts 102 (e.g., via the log generation logic 115). Such traces or other logs may be stored in their obfuscated form, with the support platform 101 utilizing the log de-obfuscation logic 120 to de-obfuscate the traces or other logs as part of providing support services to the production hosts 102 and MPIO management station 116. The support platform 101 may also or alternatively store de-obfuscated traces or other logs in the log database 208, or possibly encrypted mapping files used by the log de-obfuscation logic 120. The log database 208 in some embodiments is implemented using one or more storage systems or devices associated with the support platform 101.

Although not explicitly shown in FIGS. 1 and 2, one or more input-output devices such as keyboards, displays or other types of input-output devices may be used to support one or more user interfaces to the support platform 101, the MPIO management station 116 (e.g., to a graphical user interface (GUI) thereof to provide trace or log analysis), as well as to support communication between the support platform 101, the MPIO management station 116, the production hosts 102, and other related systems and devices not explicitly shown.

The support platform 101 may be operated by a hardware vendor that manufactures and sells computing devices (e.g., desktops, laptops, tablets, smartphones, etc.), and the production hosts 102 and/or MPIO management station 116 may represent computing devices sold by that hardware vendor. Alternatively, or additionally, the support platform 101 may be operated by a software vendor that provides software (e.g., MPIO drivers 112, etc.) to the production hosts 102. To do so, the support platform 101 may utilize code obfuscation generation logic 210 to generate such software or portions thereof (e.g., such as one or more Java archives or JAR files bundled as part of the software) in obfuscated form. The obfuscated code distribution logic 118 is configured to distribute such obfuscated code portions to the production hosts 102. In some embodiments, the obfuscated code portions are distributed to the MPIO management station 116, which then distributes the obfuscated code to the production hosts 102 utilizing its own instance of the obfuscated code distribution module 116. In other embodiments, the obfuscated code portions may be distributed directly to the production hosts 102 from the support platform 101.

It should be noted that the support platform 101 is not required to be operated by a hardware vendor that manufactures and sells computing devices, or a software vendor that sells software to computing devices. Instead, the support platform 101 may be offered as a service to provide support for computing devices that are sold by any number of hardware vendors, and/or to provide support for software that is sold by any number of software vendors. The production hosts 102 and MPIO management station 116 may subscribe to the support platform 101, so as to receive support including troubleshooting of hardware and software components of the production hosts 102 and MPIO management station 116. Various other examples are possible.

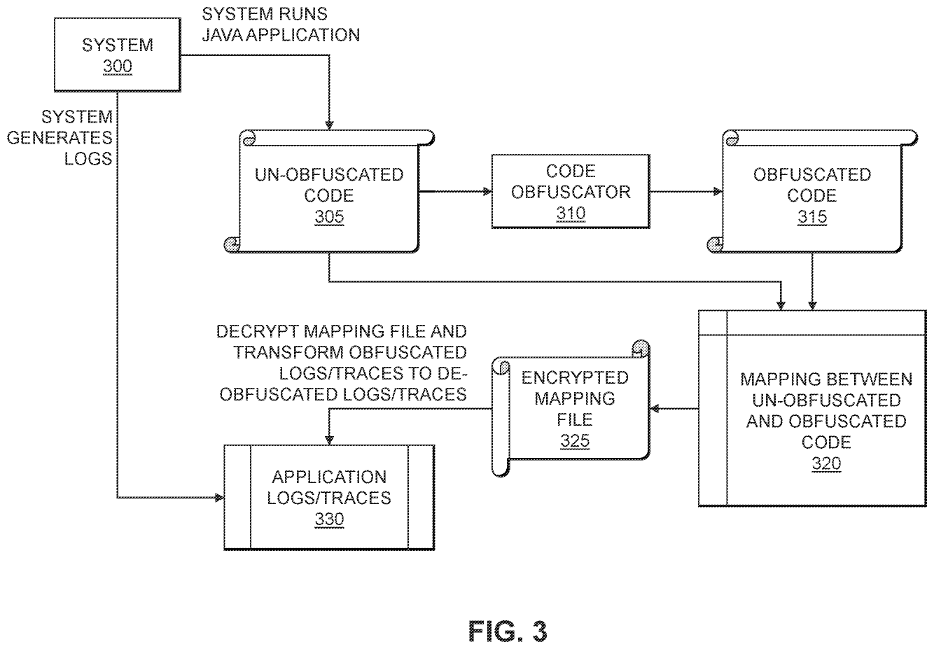

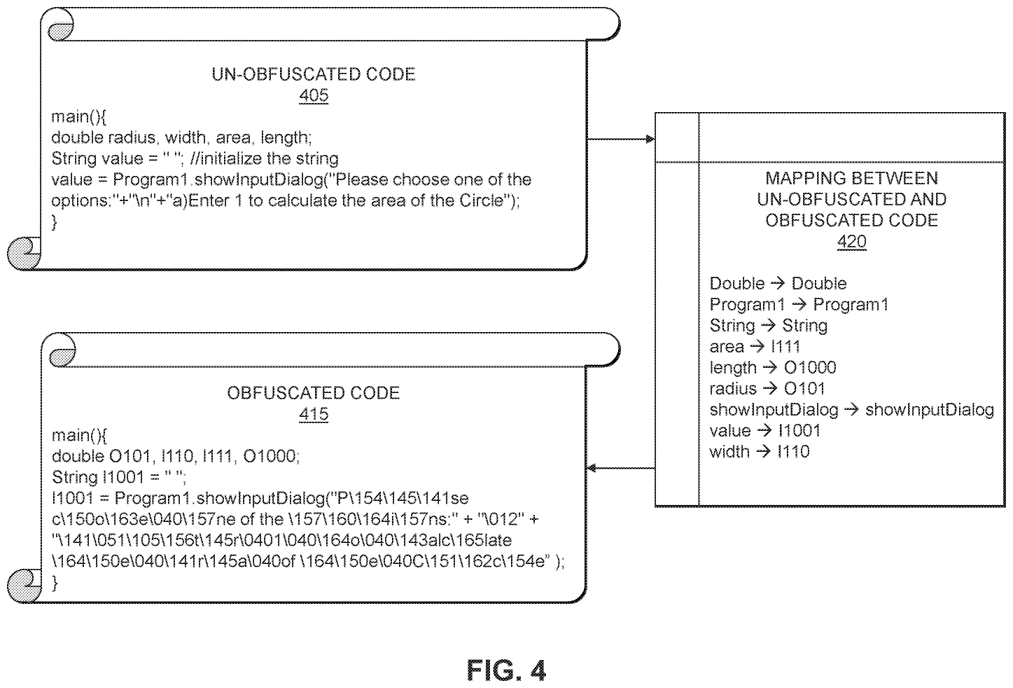

FIG. 3 illustrates a system flow for generating and analyzing obfuscated traces or logs. A system 300 runs a Java application, and is assumed to have an integrated code obfuscator 310 for generating obfuscated code 315 from un-obfuscated code 305, where the obfuscated code 315 is modified lexically. The system 300 keeps a mapping 320 between the un-obfuscated code 305 and obfuscated code 315. The mapping 320 may be stored in an encrypted mapping file 325, which is used to decrypt traces or other logs 330 generated by the system 300 (e.g., to transform the obfuscated traces or other logs to un-obfuscated traces or other logs). The mapping 320 includes a mapping of tags and modifications to the code in a text file that is encrypted utilizing an encryption module and then saved as the encrypted mapping file 325. FIG. 4 shows an example of un-obfuscated code 405, obfuscated code 415 and a mapping 420 between the un-obfuscated code 405 and the obfuscated code 415.

The encrypted mapping file 325 may be later decrypted using a key. The key may be accessible to an entity that is responsible for providing support services to the system 300. For example, the system 300 may represent one of the production hosts 102, where the key is accessible to the MPIO management station 116 or support platform 101. In this way, the obfuscated traces or other logs may be modified to the actual program code, and the transformed traces or other logs can be shared with engineering or another support entity to trace errors or otherwise perform system analysis. The un-obfuscated code 305 is illustratively modified to produce the obfuscated code 315 in such a way that even if the obfuscated code 315 is decompiled using an available de-compiler, the decompiled code would still be obfuscated such that it would not be possible to read or understand the functionality of the un-obfuscated code 305. Advantageously, the system 300 (or entities providing support therefore, such as where the system 300 is one of the production hosts 102 and the entity providing support is the MPIO management station 116, the support platform 101, or combinations thereof) enables getting obfuscated traces or other logs back to an un-obfuscated form representing actual program behavior to understand the traces or other logs.

Obfuscation is achieved in some embodiments utilizing a data modification algorithm. The mapping 320 may be encrypted using a key, with a salt added to it, to obtain the encrypted mapping file 325 that prevents unauthorized access.

In some embodiments, the techniques described herein for obfuscation of software code of applications, and for de-obfuscating logs produced from the obfuscated software code, may be used for storage and licensing of “in-house” software solutions of a given enterprise. For example, an enterprise such as a business or other organization may build and ship various software products for use by members of that organization. If such software products are built and shipped without obfuscation, the software products are simple to reverse engineer and end-users may tamper with their implementation. For example, some applications or software products may be bundled with various Java archives or JAR files. In some cases, the JAR files are built internally specifically for certain functionality such as licensing of the software products. If such JAR files are reverse engineered, they may be modified to gain unlimited access to a software product or one or more features thereof. Using the techniques described herein, security may be provided for Java archives and other portions of software code that are bundled in a software product. By integrating such techniques into the build process internally for an organization, to obfuscate archive files that are bundled internally within software products and shared as part of the software products to prevent malicious users from reverse engineering and tampering with them.

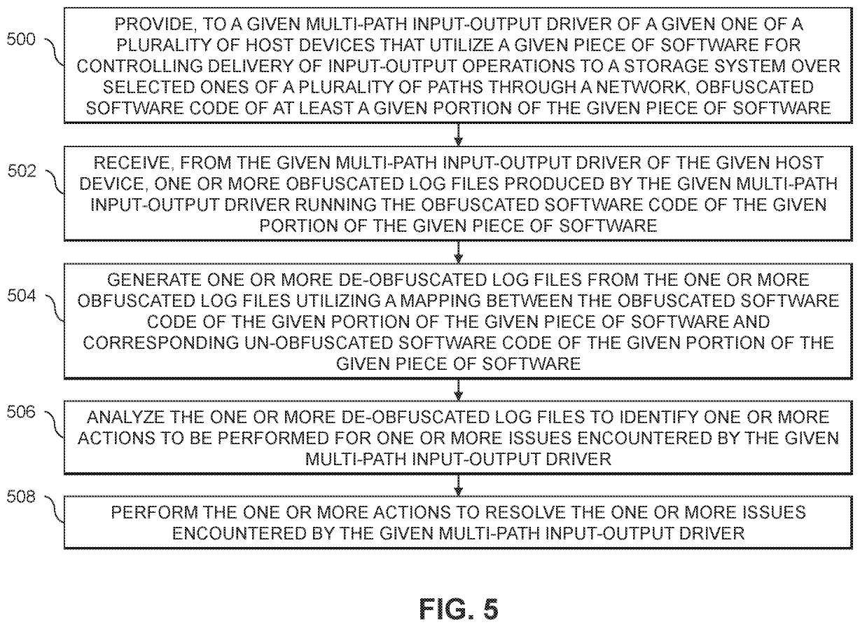

An exemplary process for de-obfuscation of obfuscated logs produced by running obfuscated code of one or more software products will now be described in more detail with reference to the flow diagram of FIG. 5. It is to be understood that this particular process is only an example, and that additional or alternative processes for de-obfuscation of obfuscated logs produced by running obfuscated code of one or more software products may be used in other embodiments.

In this embodiment, the process includes steps 500 through 508. The FIG. 5 process may be performed by the MPIO management station 116 (e.g., a management appliance such as PPMA) that is configured to manage the MPIO drivers 112 of the host devices 102 providing respective production hosts for the given piece of software in an enterprise system. The MPIO management station 116 may be configured to communicate with the host devices 102 over a private network not accessible to the support platform 101 providing support services for the given piece of software. Alternatively, the FIG. 5 process may be performed by the support platform 101, or by combination of the support platform 101 and the MPIO management station 116 utilizing the obfuscated code distribution logic 118 and the log de-obfuscation logic 120.

The FIG. 5 process begins with step 500, providing, to a given MPIO driver (e.g., MPIO driver 112-1) of a given host device (e.g., host device 102-1), obfuscated software code of at least a given portion of a given piece of software. The given piece of software, for example, may comprise the path selection logic 114-1 or other software used to control delivery of IO operations to the storage array 105 over selected ones of a plurality of paths through the SAN 104. The given portion of the given piece of software may comprise one or more archive files bundled with the given piece of software, such as one or more Java archive or JAR files. The one or more archive files bundled with the given piece of software may be configured to provide access authorization control (e.g., such as licensing) for the given piece of software.

In step 502, one or more obfuscated log files produced by the MPIO driver 112-1 running the obfuscated software code of the given portion of the given piece of software are received. One or more de-obfuscated log files are generated from the one or more obfuscated log files in step 504. Step 504 may utilize a mapping between the obfuscated software code of the given portion of the given piece of software and corresponding un-obfuscated software code of the given portion of the given piece of software. Step 504 may include decrypting an encrypted mapping file utilizing a decryption key, the decryption key not being known to the MPIO driver 112-1. The mapping file may comprise a mapping of lexical modifications of one or more code terms in the un-obfuscated software code of the given portion of the given piece of software that produce the obfuscated software code of the given portion of the given piece of software. The mapping file may also or alternatively comprise a mapping of syntactic modifications of one or more code terms in the un-obfuscated software code of the given portion of the given piece of software that produce the obfuscated software code of the given portion of the given piece of software.

In step 506, the one or more de-obfuscated log files are analyzed to identify one or more actions to be performed for one or more issues encountered by the MPIO driver 112-1. One or more actions are performed in step 508 to resolve the one or more issues encountered by the MPIO driver 112-1. Step 508 may comprise modifying the given portion of the given piece of software, obfuscating software code of the modified portion of the given piece of software, and providing the obfuscated software code of the modified portion of the given piece of software to the MPIO driver 112-1. Step 508 may comprise applying one or more remedial actions to the MPIO driver 112-1, such as updating a version of the given piece of software utilized by the MPIO driver 112-1, modifying a configuration of the host device 102-1 implementing the MPIO driver 112-1.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for de-obfuscation of obfuscated logs produced by running obfuscated code of one or more software products will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for de-obfuscation of obfuscated logs produced by running obfuscated code of one or more software products as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, software programs, obfuscation techniques, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
providing, to a given multi-path input-output driver of a given one of a plurality of host devices that utilize a given piece of software for controlling delivery of input-output operations to a storage system over selected ones of a plurality of paths through a network, obfuscated software code of at least a given portion of the given piece of software;
receiving, from the given multi-path input-output driver of the given host device, one or more obfuscated log files produced by the given multi-path input-output driver running the obfuscated software code of the given portion of the given piece of software;
generating one or more de-obfuscated log files from the one or more obfuscated log files utilizing a mapping between the obfuscated software code of the given portion of the given piece of software and corresponding un-obfuscated software code of the given portion of the given piece of software;
analyzing the one or more de-obfuscated log files to identify one or more actions to be performed for one or more issues encountered by the given multi-path input-output driver; and
performing the one or more actions to resolve the one or more issues encountered by the given multi-path input-output driver.

2. The apparatus of claim 1 wherein the at least one processing device comprises a management appliance configured to manage multi-path input-output drivers of the plurality of host devices providing respective production hosts for the given piece of software in an enterprise system.

3. The apparatus of claim 2 wherein the at least one processing device is configured to communicate with the plurality of host devices over a private network not accessible to a support platform providing support services for the given piece of software.

4. The apparatus of claim 1 wherein the at least one processing device comprises a support platform providing support services for the given piece of software to the plurality of host devices.

5. The apparatus of claim 4 wherein providing the obfuscated software code of the given portion of the given piece of software to the given multi-path input-output driver comprises providing the obfuscated software code to a management appliance configured to manage multi-path input-output drivers of the plurality of host devices providing respective production hosts for the given piece of software in an enterprise system, the management appliance distributing the obfuscated software code of the given portion of the given piece of software to the given multi-path input-output driver.

6. The apparatus of claim 1 wherein the given portion of the given piece of software comprises one or more archive files bundled with the given piece of software.

7. The apparatus of claim 6 wherein the one or more archive files comprise one or more Java archive files.

8. The apparatus of claim 6 wherein the one or more archive files bundled with the given piece of software are configured to provide access authorization control for the given piece of software.

9. The apparatus of claim 1 wherein generating the one or more de-obfuscated log files from the one or more obfuscated log files utilizing the mapping between the obfuscated software code of the given portion of the given piece of software and corresponding un-obfuscated software code of the given portion of the given piece of software comprises decrypting an encrypted mapping file utilizing a decryption key, the decryption key not being known to the given multi-path input-output driver.

10. The apparatus of claim 1 wherein the mapping file comprises a mapping of lexical modifications of one or more code terms in the un-obfuscated software code of the given portion of the given piece of software that produce the obfuscated software code of the given portion of the given piece of software.

11. The apparatus of claim 1 wherein the mapping file comprises a mapping of syntactic modifications of one or more code terms in the un-obfuscated software code of the given portion of the given piece of software that produce the obfuscated software code of the given portion of the given piece of software.

12. The apparatus of claim 1 wherein performing the one or more actions to resolve the one or more issues encountered by the given multi-path input-output driver comprises:
modifying the given portion of the given piece of software;
obfuscating software code of the modified portion of the given piece of software; and
providing the obfuscated software code of the modified portion of the given piece of software to the given multi-path input-output driver.

13. The apparatus of claim 1 wherein performing the one or more actions to resolve the one or more issues encountered by the given multi-path input-output driver comprises applying one or more remedial actions to the given multi-path input-output driver.

14. The apparatus of claim 13 wherein applying the one or more remedial actions to the given multi-path input-output driver comprise at least one of:
updating a version of the given piece of software utilized by the given multi-path input-output driver; and
modifying a configuration of the given host device implementing the given multi-path input-output driver.

15. A method comprising steps of:
providing, to a given multi-path input-output driver of a given one of a plurality of host devices that utilize a given piece of software for controlling delivery of input-output operations to a storage system over selected ones of a plurality of paths through a network, obfuscated software code of at least a given portion of the given piece of software;
receiving, from the given multi-path input-output driver of the given host device, one or more obfuscated log files produced by the given multi-path input-output driver running the obfuscated software code of the given portion of the given piece of software;
generating one or more de-obfuscated log files from the one or more obfuscated log files utilizing a mapping between the obfuscated software code of the given portion of the given piece of software and corresponding un-obfuscated software code of the given portion of the given piece of software;
analyzing the one or more de-obfuscated log files to identify one or more actions to be performed for one or more issues encountered by the given multi-path input-output driver; and
performing the one or more actions to resolve the one or more issues encountered by the given multi-path input-output driver;
wherein the method is performed by at least one processing device comprising a processor coupled to a memory.

16. The method of claim 15 wherein the given portion of the given piece of software comprises one or more archive files bundled with the given piece of software.

17. The method of claim 16 wherein the one or more archive files bundled with the given piece of software are configured to provide access authorization control for the given piece of software.

18. A computer program product comprising a non-transitory processor-readable storage medium having stored therein program code of one or more software programs, wherein the program code when executed by at least one processing device causes the at least one processing device to perform steps of:
providing, to a given multi-path input-output driver of a given one of a plurality of host devices that utilize a given piece of software for controlling delivery of input-output operations to a storage system over selected ones of a plurality of paths through a network, obfuscated software code of at least a given portion of the given piece of software;
receiving, from the given multi-path input-output driver of the given host device, one or more obfuscated log files produced by the given multi-path input-output driver running the obfuscated software code of the given portion of the given piece of software;
generating one or more de-obfuscated log files from the one or more obfuscated log files utilizing a mapping between the obfuscated software code of the given portion of the given piece of software and corresponding un-obfuscated software code of the given portion of the given piece of software;
analyzing the one or more de-obfuscated log files to identify one or more actions to be performed for one or more issues encountered by the given multi-path input-output driver; and
performing the one or more actions to resolve the one or more issues encountered by the given multi-path input-output driver.

19. The computer program product of claim 18 wherein the given portion of the given piece of software comprises one or more archive files bundled with the given piece of software.

20. The computer program product of claim 19 wherein the one or more archive files bundled with the given piece of software are configured to provide access authorization control for the given piece of software.
